(19) United States
(12) Patent Application Publication
(10) Pub. No.: US 2011/0259129 A1
(43) Pub. Date: Oct. 27, 2011

(54) AUTOMATIC ANALYZER AND SUPPORT SYSTEM THEREFOR

(75) Inventors: Sumiko Murata, Hitachinaka (JP); Satoshi Shibuya, Hitachinaka (JP); Kazuhiro Nakamura, Nara (JP)

(73) Assignee: Hitachi High-Technologies Corporation

(21) Appl. No.: 13/141,882

(22) PCT Filed: Dec. 4, 2009
(86) PCT No.: PCT/JP2009/006613

§ 371 Date: Jun. 23, 2011

(30) Foreign Application Priority Data
Dec. 26, 2008 (JP) 2008-331819

(51) Int. Cl. G01D 7/00

(52) U.S. Cl. 73/866.3

(57) ABSTRACT

With a conventional automatic analyzer, when a standard solution sample or quality control sample that require subjecting to reanalysis is identified during analysis to prepare for subsequent analysis, it will take time until the sample in question is identified.

An automatic analyzer according the present invention includes display means for displaying identification information by which measurement status of a standard solution sample or a quality control sample can be identified. The display means includes a function of selectively displaying the identifier following a change in measurement status for each sample. Thus an operator can immediately recognize a sample having been used for analysis, leading to shortening the time duration up to subsequent analysis.

### TECHNICAL FIELD

The present invention relates to an automatic analyzer which analyzes components in a biological sample and to a support system therefor. More particularly, the invention relates to the efficient operation and management of calibration and quality control in the automatic analyzer.

### BACKGROUND ART

An automatic analyzer analyzes components in a biological sample such as blood and urine by using a reagent. Such an analyzer needs to perform calibration (working curve calibration operation) and quality control for maintaining favorable conditions of the automatic analyzer before starting analytical processing, or at intervals predetermined for each reagent during analytical processing, or as required during analytical processing.

Calibration is performed by using a standard solution sample having a concentration predetermined for each item to be analyzed. Based on measurements, a calibration curve denoting a relation between the result of absorbance measurement and the concentration is generated. Further, quality control is performed using a quality control sample having a concentration predetermined for each item to be analyzed, thereby validating the measurement result. When the predetermined concentration largely differs from the measured concentration, possible causes include the degradation of reagent and a failure in the analysis apparatus. Since an effective time for each item to be analyzed is involved in calibration and quality control, the calibration and quality control need to be performed again when the effective time has elapsed. After the calibration and quality control are performed, when the result does not fall within a predetermined range, their operations is determined to fail, and the associated calibration and quality control must be performed again. Further, when a reagent is supplied from a new reagent bottle, it is necessary to again perform calibration each item to be analyzed.

Patent Document 1 teaches an automatic chemical analyzer capable of calibration. With this prior art, the calibration time interval is stored for each item to be analyzed, and warning data may be displayed on a display unit by a control unit for an item to be analyzed for which the effective time of the calibration curve has elapsed. Further, when a calibration menu screen is displayed on the display unit, all items to be analyzed handled by the analysis apparatus are displayed in a list form, where an alarm symbol is attached to only items to be analyzed for which the effective time has elapsed.

Prior Art Document

Patent Document

Patent Document 1: JP-A-61-038464

### SUMMARY OF THE INVENTION

### Problem to be Solved by the Invention

The invention discussed in Patent document 1 makes it possible to notify an operator of the fact that it has become necessary to perform calibration or quality control for each item to be analyzed. However, judging from only names of items to be analyzed whose measurement is requested, the operator does not know which calibrator and which quality control sample are to be set. Specifically, when an existent analysis apparatus fails analysis, the existent analysis apparatus identifies a standard solution or a quality control sample to be subjected to reanalysis. In such a case, even if an analysis is to be performed subsequently, the operator may not be informed of the information about the sample state and the sample used for analysis, taking time until a target sample is identified. When the sample measurement status such as failed analysis is displayed in real time, and the identification information (sample ID) on the sample whose analysis failed and the identification information (rack ID) on the rack mounted with the sample are displayed, the operator can immediately recognize the sample that has been used for analysis in question. This makes it easier to prepare a sample to be used for reanalysis, thus shortening the time duration up to the subsequent analysis.

An obj ect of the present invention is to provide an automatic analyzer capable of reliably performing calibration or quality control. Specifically, the automatic analyzer can easily notify the operator of the status of the sample having been used during calibration or quality control analysis, as well as the remaining time duration until analysis of the used sample is completed, thereby allowing a sample required for reanalysis to be prepared in advance.

### Means for Solving the Problem

A configuration of the present invention for achieving the above-mentioned object will be described below.

The present invention is directed to an automatic analyzer which automatically analyzes a sample to determine concentrations of test items. The automatic analyzer includes display means which identifies the measurement status of a standard solution sample or quality control sample as analysis started, analysis in progress, failed analysis, or analysis successfully completed. The display means has a function of changing the status display following a change in measurement status for each sample.

The automatic analyzer is provided with a function for recognizing the measurement status of each sample as Started, In Progress, Failed, or Succeeded for each sample.

### EFFECT OF THE INVENTION

According to the present invention, the operator checks the sample identifier information about a standard solution or quality control sample displayed in the measurement result monitoring screen of an operation unit of the automatic analyzer, so that the operator can know the sample measurement status before the result of calibrator/quality control is output, thus reliably and quickly preparing for the subsequent analysis.

The operator can know items to be analyzed of the standard solution or quality control sample currently being measured, whereby the operator can immediately determine whether the items to be analyzed are excessive and insufficient.

When the measurement status is “failed analysis”, the operator can know the status of all other items to be analyzed that have been analyzed by using the same sample, enabling preparation for reanalysis of all items to be analyzed reliably and quickly.

### BRIEF DESCRIPTION OF THE DRAWINGS

FIG. 1 illustrates a schematic configuration of an automatic analyzer according to an embodiment of the present invention.

FIG. 2 illustrates a quality control overview screen of the automatic analyzer according to the present invention.

FIG. 3 illustrates a calibrator overview screen of the automatic analyzer according to the present invention.

FIG. 4 illustrates the order of displaying an identifier of quality control samples in the automatic analyzer according to the present invention.

FIG. 5 illustrates the order of displaying an identifier of standard solution samples in the automatic analyzer according to the present invention.

FIG. 6 illustrates a detailed information screen of the quality control sample of the automatic analyzer according to the present invention.

### MODE FOR CARRYING OUT THE INVENTION

An embodiment of the present invention will be described below with reference to the accompanying drawings.

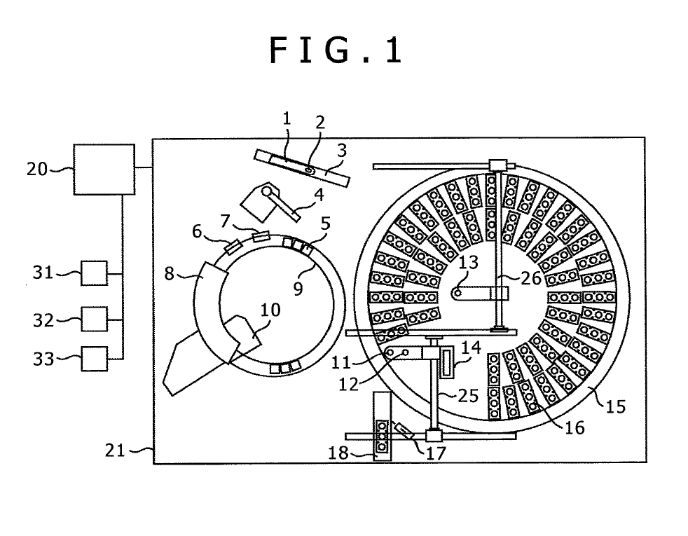

Embodiments of the present invention will be described below with reference to FIGS. 1 to 5.

First, an exemplary configuration of an automatic analyzer according to the present invention will be described below.

FIG. 1 is a schematic configuration of the automatic analyzer capable of analyzing serum, plasma, or urine as a biological sample.

A rack 1 mounting standard solution samples is supplied by a conveyance mechanism 3. The sample is held by the rack 1 and positioned at a location at which to suction the sample, followed by suctioning by a sample probe 4. The sample is then discharged onto a reaction vessel 5 on a reaction disk 9 at the sample dispensing position. The reaction vessel 5 having received the sample is moved to the first reagent dispensing position by the rotation of the reaction disk 9. At this position, a first reagent in a reagent cassette 16 held by a reagent disk 15 is dispensed onto the reaction vessel 5 by a first reagent probe 11. The reaction vessel 5 having received the first reagent is moved to the stirring position, where the sample and the first reagent are stirred by a stirring unit 6.

Further, when addition of a second reagent is required, the reaction vessel 5 subjected to stirring processing is moved to the second reagent dispensing position. At this position, a second reagent in the same reagent cassette 16 as that for the first reagent held by the reagent disk 15 is dispensed onto the reaction vessel 5 by a second reagent probe 13. The reaction vessel 5 dispensed is moved to the stirring position at which the sample and the first and second reagents in the reaction vessel 5 are stirred by a stirring unit 7 to generate a reaction solution.

The reaction vessel 5 containing the reaction solution is moved to the measurement position at which multi-wavelength absorbance measurement of the reaction solution is performed by an optical detector 10.

A signal output from the optical detector 10 is converted to digital form by an analog-to-digital converter (not illustrated) . Based on this data, a formula of calibration curve is made to generate a calibration curve, the success or failure of calibration is determined, and the result of the determination is transmitted to a storage unit 30. The success of calibration refers to a state where a calibration curve is generated and the generated calibration curve is not largely deviated from ones experientially obtained in the past. The failure of calibration refers to a state where a calibration curve is not generated or a generated calibration curve is largely deviated from ones experientially obtained in the past. A controller 20 stores data on calibration curves experimentally obtained in the past as well as data regarding a permissible deviation range. The success or failure of calibration is determined based on these pieces of data.

The controller 20 may transmit the obtained information about the formula of calibration curve to the storage unit 30 without determining the success or failure of calibration. Then, the storage unit 30 may store the data on calibration curves experimentally obtained in the past and the data regarding a permissible deviation range to determine the success or failure of calibration.

The rack 1 mounting a quality control sample is supplied by the conveyance mechanism 3. Then, similarly to the standard solution sample, multi-wavelength absorbance measurement of the reaction solution is performed. Quality control refers to a work for measuring a sample (quality control sample) having a known concentration to determine whether or not the result of measurement falls within a predetermined range, thus determining whether or not the automatic analyzer, the reagent, and the like are maintained in favorable states.

Similarly to the standard solution sample, a signal output from the optical detector 10 is converted to digital form by the analog-to-digital converter. Based on this data, the controller 20 determines the success or failure of quality control. The success of quality control refers to a state where the precision is measured and the measured precision is maintained in a predetermined accuracy. The failure of quality control refers to a state where the precision is not measured or a measured precision is not maintained in the predetermined accuracy. The success or failure of quality control determined is transmitted to the storage unit 30.

Without determining the success or failure of quality control, the controller 20 may transmit to the storage unit 30 information about success or failure of measurement or only information about the measured values when measurement is successful. The storage unit 30 may determine the success or failure of quality control.

An operation unit 31 includes, for example, a keyboard and a CRT to display calibration curve information and quality control information, and enable the operator to perform an input operation. A storage unit 32 includes a hard disk that stores analysis parameters, reagent information, calibration curve information, quality control information, and so on.

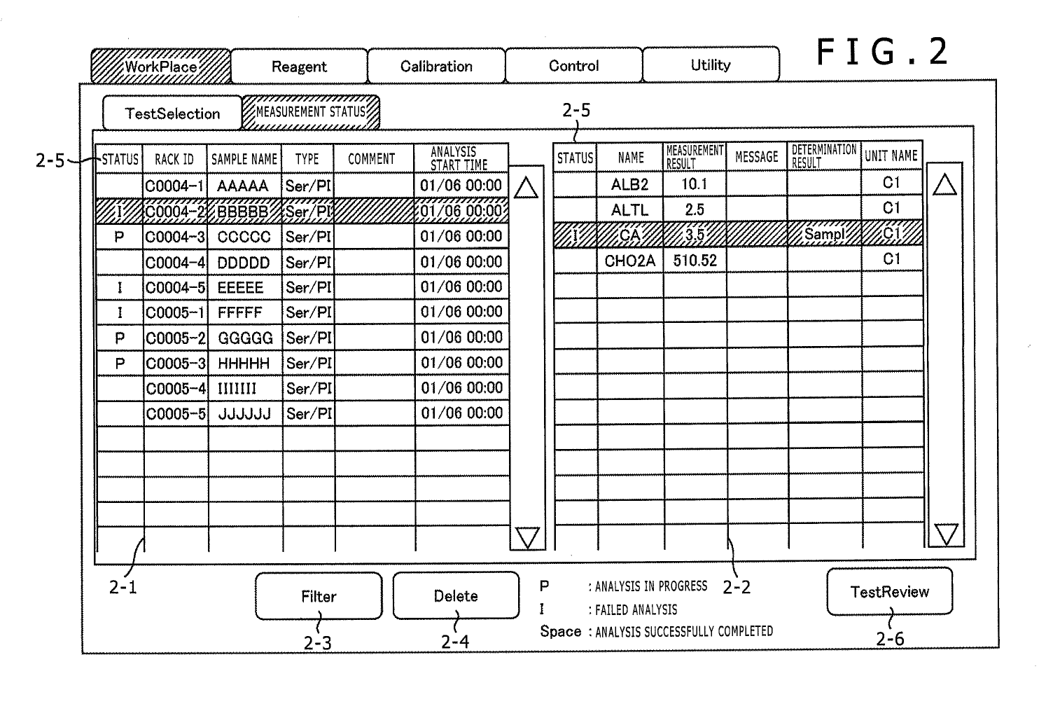

FIG. 2 illustrates a quality control overview screen of the automatic analyzer according an embodiment of the present invention.

The screen of FIG. 2 displays the measurement status for each quality control sample. The display portion of the screen includes display areas 2-1 and 2-2 which will be described below.

The display area 2-1 displays a list of quality control samples whose analysis has started. Examples of information displayed include measurement status identifiers of each quality control sample, rack identification numbers mounting each sample, sample names, sample loaded time, sample production lot numbers, sample dispensing time, and remaining time duration up to completion of sample measurement.

The measurement status identifier 2-5 of each quality control sample recognizably displays such that the status, i.e., “analysis in progress”, “failed analysis”, and “analysis successfully completed” are identifiable. A method for changing the measurement status display will be described below.

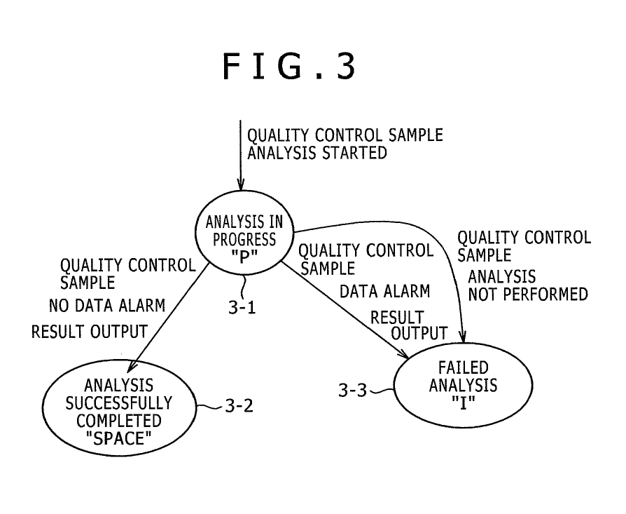

FIG. 3 illustrates the order of displaying the measurement status identifier.

An identification information reading unit 50 reads the identification information about a rack and the identification information about each sample vessel on the rack. When the reading unit 50 reads the identification information (bar code), the measurement status changes to “in progress” (P) 3-1. When analysis results of all items to be analyzed do not indicate any failures concerning samples, the measurement status changes to “analysis successfully completed” (space) 3-2. When the analysis result of any one item is invalid or when the result cannot be output due to interruption during analysis, the measurement status changes to “failed analysis” (I) 3-3.

Sample information can be extracted based on the measurement status of a quality control sample. Specifically, when the operator presses a Filter button 2-3 to open a screen for setting a specified measurement status and then set an extraction condition thereto, quality control samples associated with the measurement status of “analysis in progress”, “failed analysis”, and “analysis successfully completed” are extracted and displayed in the display area 2-1.

Further, each quality control sample can be deleted. The operator presses a Delete button 2-4 to delete a quality control sample selected in the display area 2-1.

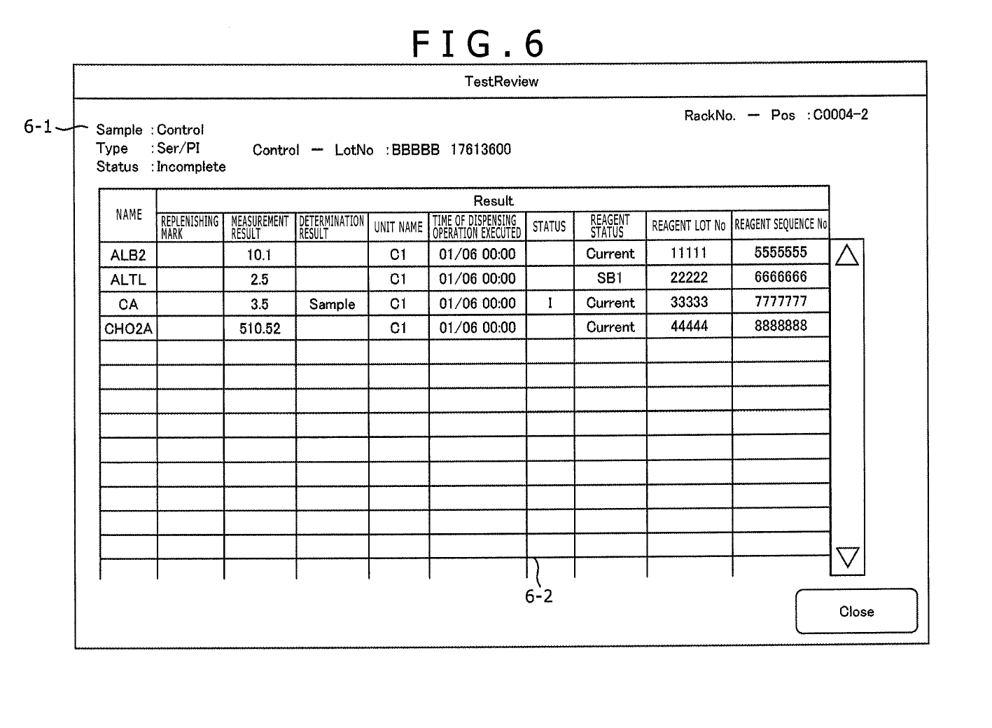

Further, detailed information on each quality control sample can be displayed. When the operator presses a TestReview (2-6) button, a TestReview screen (FIG. 6) is displayed.

A display area 6-1 displays information about each quality control sample. Information that is displayed on that area includes sample types, quality control sample names, quality control sample lot numbers, measurement status, rack numbers and positions used for analysis.

A display area 6-2 displays information about items analyzed for each quality control sample. Information that is displayed on that area includes names of items to be analyzed, measurement results, analyzer types used for analysis, analysis start time, measurement status, and status, lot numbers, and sequence numbers of reagents used.

The display area 2-2 displays measurement status of items for each of quality control samples whose analysis has started. The display area 2-2 displays information about items measured for a sample selected in the display area 2-1. Information that is displayed on that area includes item names, measurement results, measurement result messages, determination information on measurement results, and analysis unit names.

These pieces of display information are an example, and may be necessary information that depends on items for each quality control sample. It can be easily conceivable that other information could be displayed in the display areas.

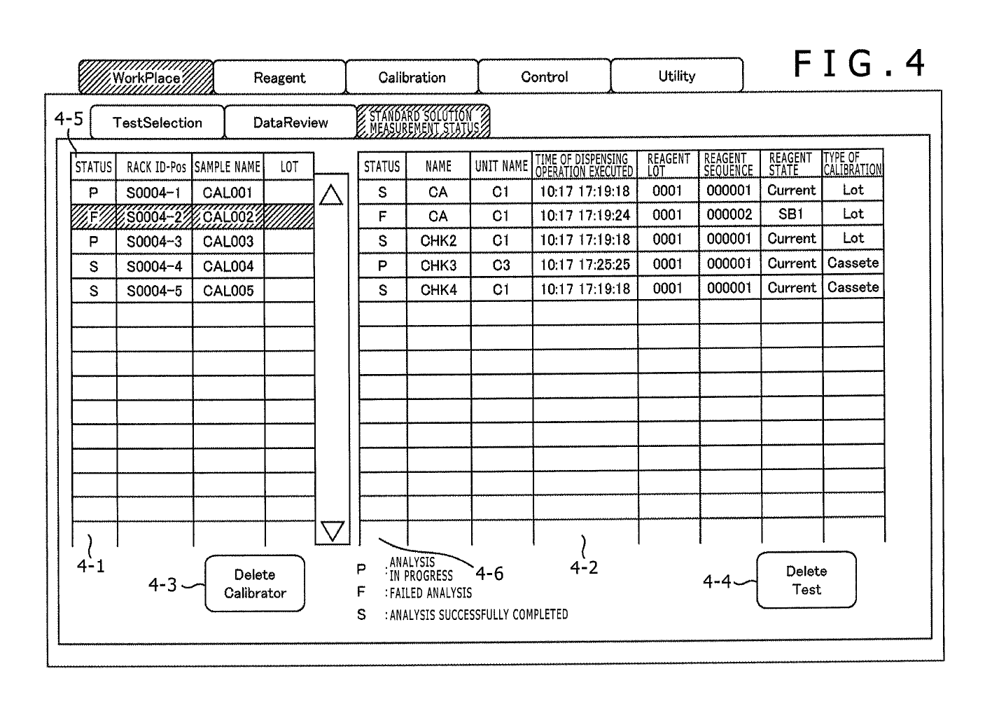

FIG. 4 illustrates a calibrator overview screen of the automatic analyzer according to an embodiment of the present invention.

The screen of FIG. 4 displays measurement status for each quality control sample. The screen includes display areas 4-1 and 4-2. These display areas will be described below.

The display area 4-1 displays a list of standard solution samples whose analysis has started. Information that is displayed on that area includes the standard solution sample measurement status identifiers, rack IDs and rack position numbers used for analysis, sample names, and sample lot numbers.

A standard solution sample measurement status identifier 4-5 recognizably displays such that the status, i.e., “analysis in progress”, “failed analysis”, and “analysis successfully completed” are identifiable. A method for changing the measurement status display will be described below.

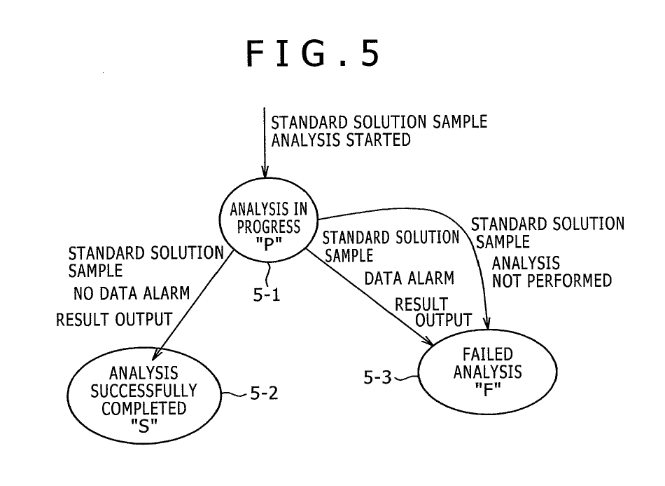

FIG. 5 illustrates the order of displaying the measurement status identifier.

The identification information reading unit 50 reads the identification information about a rack and the identification information about each sample vessel on the rack. When the reading unit 50 reads the identification information (bar code), the measurement status changes to “in progress” (P) 5-1. When analysis results of all items to be analyzed do not indicate any failures concerning samples, the measurement status changes to “analysis successfully completed” (space) 5-2. When the analysis result of any one item is invalid or when the result cannot be output due to interruption during analysis, the measurement status changes to “failed analysis” (I) 5-3.

Further, each standard solution sample can be deleted. The operator presses a Delete button 4-3 to delete a standard solution sample selected in the display area 4-1. One or a plurality of samples may be selected.

The display area 4-2 displays measurement status of items for each of standard solution samples whose analysis has started. The display area 4-2 displays information about items measured for a sample selected in the display area 4-1. Information that is displayed on that area includes measurement status identifiers 4-5, item names, analysis unit names, analysis execution time, lot numbers of reagents used for analysis, sequence numbers, reagent status, and type of calibration generated.

These pieces of display information are an example, and maybe necessary information that depends on items for each standard solution sample. It can be easily conceivable that other information could be displayed in the display areas.

Further, item information in each standard solution sample can be deleted. The operator presses a Delete button 4-4 to delete the item information in a standard solution sample selected in the display area 4-2.

### DESCRIPTION OF NUMERALS

1 . . . Sample rack
2 . . . Sample vessel
2-1 . . . Screen displaying quality control sample analysis status
2-2 . . . Screen displaying status of analyzed items for each quality control sample
2-3 . . . Button for displaying screen for selecting quality control sample extraction condition
2-4 . . . Button for displaying screen for deleting quality control sample
2-5 . . . Area displaying quality control sample measurement status
3 . . . Rack conveyance line
4 . . . Sample dispensing probe
4-1 . . . Screen displaying analysis status of standard solution sample
4-2 . . . Screen displaying status of analyzed items for each standard solution sample
4-3 . . . Button for displaying screen for deleting standard solution sample
4-4 . . . Button for displaying screen for deleting analyzed items for each standard solution sample
4-5 . . . Area displaying standard solution sample measurement status
4-6 . . . Area displaying measurement status of analyzed item for each standard solution sample
5 . . . Reaction vessel
6, 7 . . . Stirring mechanism
8 . . . Cleaning mechanism
9 . . . Reaction disk
10 . . . Optical detector
11, 13 . . . Reagent dispensing probe
12 . . . Reagent opening mechanism
14 . . . Cassette conveyance mechanism
15 . . . Reagent disk
16 . . . Reagent cassette
17 . . . Reagent bar code reading unit
18 . . . Reagent cassette input slot
20 . . . Controller
31 . . . Operation unit
32 . . . Storage unit

1. An automatic analyzer comprising:
display means for displaying identification information by which measurement status of at least one of a standard solution sample and a quality control sample can be identified,
wherein the display means includes control means for selectively displaying the identification information following a change in measurement status for each standard solution sample or quality control sample.

2. The automatic analyzer according to claim 1,
wherein the identification information is used to identify the following: analysis started, analysis in progress, failed analysis, and analysis successfully completed.

3. An automatic analyzer comprising:
display means for displaying identification information by which measurement status of at least one of a standard solution sample and a quality control sample can be identified,
wherein the display means includes control means for selectively displaying the identification information following a change in measurement status for each item to be analyzed of the standard solution sample or quality control sample.

4. The automatic analyzer according to claim 1,
wherein the display means displays identification information allowing identification of the measurement status of items measured for the sample for each item to be analyzed of the standard solution sample or quality control sample together with identification information for each standard solution sample or quality control sample.

5. The automatic analyzer according to claim 4,
wherein the measurement status identification information for the item is used to identify the following: measurement started, measurement in progress, failed measurement, and measurement successfully completed.

6. The automatic analyzer according to claim 1,
wherein the display means displays at least one of sample mounting rack identifiable number, sample name, time of sample load, lot number with which samples were produced, time of sample dispensing, and remaining time duration up to completion of sample measurement.

7. The automatic analyzer according to claim 4,
wherein the display means displays at least one of item name, time of sample dispensing for item measurement, an identifier for identifying the order of using a reagent used for item measurement, values of item measurements, and remaining time duration up to completion of sample measurement.

8. A support system for an automatic analyzer, the support system comprising:
display means for displaying identification information by which measurement status of at least one of a standard solution sample and a quality control sample can be identified,
wherein the display means includes control means for selectively displaying the identification information following a change in measurement status for each standard solution sample or quality control sample.
